(19) United States
(12) Patent Application Publication
(10) Pub. No.: US 2026/0274219 A1
(43) Pub. Date: Sep. 17, 2026

(54) METHOD FOR DECELERATING A VEHICLE COMBINATION

(71) Applicant: ZF CV Systems Global GmbH, Bern (CH)

(72) Inventors: Nikolai Flaum, Hannover (DE); Torsten Wallbaum, Duingen (DE); Florian Schwagmeyer, Uetze-Dollbergen (DE)

(21) Appl. No.: 19/673,860

(22) Filed: May 11, 2026

Related U.S. Application Data
(63) Continuation of application No. PCT/EP2024/082345, filed on Nov. 14, 2024.

(30) Foreign Application Priority Data
Nov. 21, 2023 (DE) 10 2023 132 465.9

(51) Int. Cl. B60T 8/17; B60T 8/171; B60T 8/172; B60T 8/32

(52) U.S. Cl. CPC B60T 8/1708; B60T 8/171; B60T 8/172; B60T 8/323; B60T 2250/00

(57) ABSTRACT

A method is for decelerating a vehicle combination including a tractor vehicle and a trailer vehicle. A tractor vehicle brake control unit determines a total braking force, which is to be applied jointly by a trailer brake system and a tractor vehicle brake system, when a desired deceleration is received. The brake control unit causes the trailer brake system to apply a trailer braking force and determines a tractor vehicle braking force taking into account the currently effective trailer braking force and adjusts the tractor vehicle braking force by actuating the tractor vehicle brake system. A brake control unit is for the tractor vehicle of a vehicle combination. In order to achieve the desired deceleration more quickly, in a first braking phase after receiving the desired deceleration, the tractor vehicle braking force is initially adjusted to a higher braking force level than is provided according to the braking force distribution.

### CROSS-REFERENCE TO RELATED APPLICATIONS

This application is a continuation application of international patent application PCT/EP2024/082345, filed November 14, 2024, designating the United States and claiming priority from German application 102023132 465.9, filed November 21, 2023, and the entire content of both applications is incorporated herein by reference.

### TECHNICAL FIELD

The disclosure relates to a method for decelerating a vehicle combination including a tractor vehicle and at least one trailer vehicle, wherein a brake control unit of the tractor vehicle ascertains a total braking force, which is to be applied jointly by a trailer brake system and a tractor vehicle brake system, when a desired deceleration is received.

### BACKGROUND

In utility vehicles, the wheels are generally braked by pneumatically operable wheel brakes, with each sub-vehicle of a vehicle combination having a brake system. Electronic or automated brake systems are increasingly being used, where instead of a mechanical connection between the brake pedal and the wheel brakes, the wheel brakes are operated by electronic control of the actuators of the wheel brakes. The brake pedal is then an operator control device by way of which the driver communicates their desired deceleration. Identification of the desired deceleration via pedal travel sensors and transmission via electronic signal lines is also referred to as "brake by wire". In the case of a vehicle combination, a brake control unit of the tractor vehicle receives the desired deceleration and determines a braking force distribution of the partial braking forces to be applied by a tractor vehicle brake system and a trailer brake system for optimum implementation of the desired deceleration. The brake control unit of the tractor vehicle then actuates the tractor vehicle brake system and additionally causes a trailer brake system to provide the partial braking force for the trailer vehicle.

One advantage of electronically controlled deceleration ("brake by wire") is the comparatively rapid response of the wheel brakes of a vehicle.

DE44 38 353 C2 discloses a method for electronic open-loop or closed-loop control of the brake system of a vehicle combination, wherein a tractor vehicle which can be coupled to a trailer has a brake system which is subject to electronic open-loop or closed-loop control. In the known method, a brake signal for the tractor vehicle and a brake signal for the trailer for controlling the brake system of the tractor vehicle are ascertained on the basis of the driver's braking request. The known method uses different physical variables as the brake signal, depending on the configuration of the brake system. The brake signal is transmitted pneumatically or electrically to the trailer vehicle. A pneumatic brake signal is the trailer brake pressure that the brake control unit of the tractor vehicle ascertains and provides to a coupling head for the trailer brake system. In the case of electric brakes, the brake signal can be a target current supplied to the wheel brakes.

However, it has been found that the desired deceleration is often not implemented quickly enough in the case of vehicle combinations, particularly in the case of pneumatic signal transmission between the tractor vehicle and the trailer vehicle.

### SUMMARY

It is an object of the present disclosure is to develop a method for decelerating a vehicle combination such that the desired deceleration is achieved more quickly.

According to the disclosure, this object is, for example, achieved by a method for decelerating a vehicle combination including a tractor vehicle and at least one trailer vehicle. The method includes: determining, via a brake control unit of the tractor vehicle, a total braking force, which is to be applied jointly by a trailer brake system and a tractor vehicle brake system in a braking force distribution, when a desired deceleration is received; causing, via the brake control unit, the trailer brake system to apply a trailer braking force and determine a tractor vehicle braking force taking into account a currently effective trailer braking force and adjusting the tractor vehicle braking force by actuating the tractor vehicle brake system; and, wherein, in a first braking phase after receiving the desired deceleration, the tractor vehicle braking force is initially adjusted to a higher braking force level than is provided according to the braking force distribution.

The disclosure is based on the finding that the advantages of electronic control of deceleration ("brake by wire") can only be used to a minor extent in vehicle combinations if the trailer brake system of the respectively coupled trailer vehicle is not electronically controlled and therefore the wheel brakes of the trailer vehicle respond significantly more slowly to the deceleration command. The disclosure makes provision, in a first braking phase after receiving the desired deceleration, for the tractor vehicle braking force to initially be adjusted to a higher braking force level than is provided according to the braking force distribution. The brake control unit electrically actuates the valves of the tractor vehicle brake system to apply a greater braking force than is actually provided after the total braking force is divided between the partial braking forces of the two brake systems. The rapidly responding wheel brakes of the tractor vehicle brake system can then create greater deceleration of the vehicle combination as early as in the first braking phase, in which the trailer brake system is not yet participating in the application of the total braking force (sum of the partial braking forces of the two brake systems).

The temporary increase in the partial braking force for the tractor vehicle with an electronically controlled brake system can be easily implemented by way of the brake control unit of the tractor vehicle providing a trailer brake pressure for the trailer brake system and adjusting it according to the provided partial braking force for the trailer vehicle. The partial braking force of the rapidly responding electronic brake system is adjusted to be greater than the braking force level provided by the braking force distribution.

The reaction time of the vehicle combination to the requested deceleration of the vehicle combination is significantly reduced by the initially more intensive use of the rapidly responding tractor vehicle brake system, particularly in the case of vehicle combinations in combination with conventional trailer brake systems. Furthermore, the braking distance of the vehicle combination to reliably maintain the safety distance from a vehicle travelling ahead is also reduced.

In an embodiment of the disclosure, the tractor vehicle brake system is actuated during the first braking phase to provide the total braking force according to the desired deceleration. As a result, the desired deceleration requested is temporarily built up very quickly temporarily only with the rapidly responding wheel brakes of the electronically controlled tractor vehicle brake system, as long as the comparatively slowly responding trailer brake system is not yet effective.

The first braking phase is terminated as soon as a deceleration effect of the trailer brake system occurs. The brake control unit 9 reduces the greater deceleration request according to the disclosure made of the tractor vehicle brake system in the further course of the deceleration process again, so that the braking force distribution between the tractor vehicle and the trailer vehicle is brought back into balance. In an embodiment, the braking force of the tractor vehicle brake system that is initially greater in the first braking phase is reduced to the provided level of the tractor vehicle braking force after a deceleration effect of the trailer brake system occurs in a transition phase, taking into account the current trailer braking force. This ensures that a substantially constant total braking force of the brake systems of the vehicle combination is applied during the build-up of the trailer braking force.

An occurrence of the deceleration effect of the trailer brake system, that is, an effect of braking forces of the trailer brake system on the deceleration of the vehicle combination, is established or, in an embodiment of the disclosure, assumed. In an embodiment of the disclosure, the occurrence of the deceleration effect of the trailer brake system is estimated by measuring the braking time as a forecast variable based on an evaluation of the braking time with specified parameterizations. The braking time corresponds to the previous duration of the first braking phase with modulation of the tractor vehicle braking force to a higher braking force level than is provided according to the braking force distribution. The start of the measurement of the braking time can be linked to the time of modulation of a trailer brake pressure or as early as reception of a desired deceleration. When a specified braking time is reached, a deceleration effect of the trailer brake system is assumed.

In a further embodiment of the disclosure, a forecast variable is used to monitor the deceleration effect of the trailer brake system via a coupling force sensor. The coupling force sensor detects the forces between the towing tractor vehicle and the towed trailer vehicle, with conclusions being drawn about the deceleration effect of the trailer brake system from changes in the coupling force. If a certain coupling force is detected, occurrence of a deceleration effect of the trailer brake system is assumed.

In a further embodiment, the forecast variable for monitoring the deceleration effect of the trailer brake system is derived from an evaluation of the deceleration of the tractor vehicle, which deceleration can be measured using an acceleration sensor. With knowledge of the currently effective tractor vehicle braking force, conclusions can be drawn as to whether the measured deceleration of the tractor vehicle already has to be achieved with assistance from the trailer braking force, that is, a deceleration effect of the trailer brake system can be established.

In the case of semitrailer tractors, a deceleration effect of the trailer brake system can be established by evaluating the change in axle load on at least one axle. The axle load is measured as a forecast variable for monitoring the occurrence of the deceleration effect of the trailer brake system.

### BRIEF DESCRIPTION OF DRAWINGS

The invention will now be described with reference to the drawings wherein:

FIG. 1 shows a pneumatic and electrical diagram of an embodiment of a combination of brake systems of a vehicle combination;

FIG. 2 shows a flow chart of an embodiment of a method for decelerating the vehicle combination according to FIG. 1; and,

FIG. 3 shows a graphical representation of a time profile of the partial braking forces during the deceleration.

### DETAILED DESCRIPTION

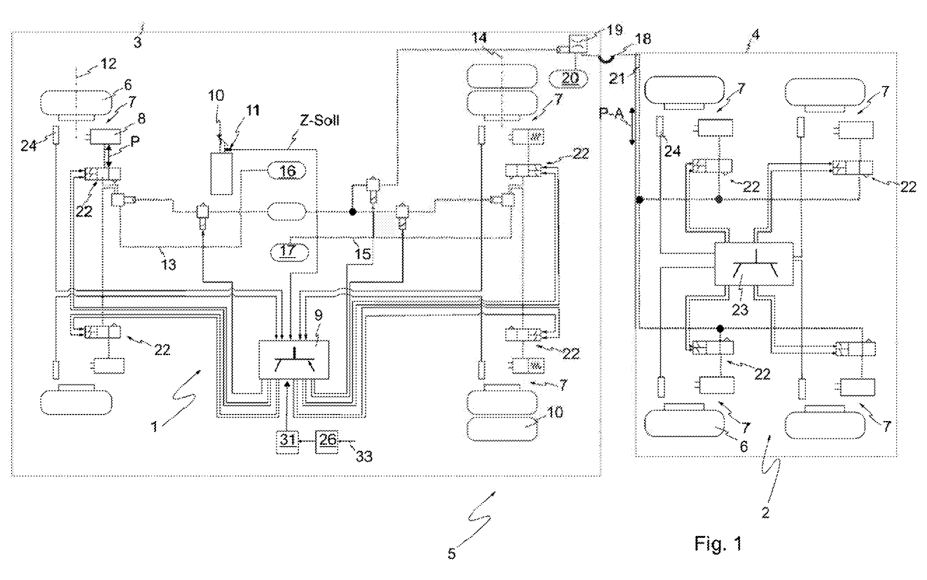

FIG. 1 shows an electrical-pneumatic diagram of a combination of pneumatic brake systems 1, 2 of the utility vehicles 3, 4 of a vehicle combination 5, namely a tractor vehicle 3 with, in the embodiment, a trailer vehicle 4. Electrical lines are shown by solid lines and pneumatic lines by dotted lines. In order to brake the wheels 6, each wheel 6 is assigned a wheel brake 7, which can be operated pneumatically via brake cylinders 8. The wheel brakes 7 exert a braking force on the rotating wheel 6 in accordance with the pneumatic brake pressure applied in each case in the brake cylinder 8 in order to decelerate the vehicle combination 5. A brake pressure P, which is electronically controlled by a brake control unit 9, acts on the wheel brakes 7 of the tractor vehicle brake system 1. A trailer brake pressure P-A, which is provided and adjusted by the brake control unit 9 of the tractor vehicle 3 in the embodiment shown, acts in the trailer brake system 2.

A brake pedal 10 is arranged in the driver's cab of the tractor vehicle 3, the position of the brake pedal being detected by a brake signal transmitter 11 connected to the brake control unit 9. The driver of the tractor vehicle 3 can specify a desired deceleration z-Soll by operating the brake pedal 10 of the brake control unit 9.

In the embodiment shown, the wheel brakes 7 of the front axle 12 of the tractor vehicle are assigned to a common first brake circuit 13 of the electronically controlled tractor vehicle brake system 1, while the wheel brakes 7 of the rear axle 14 can be operated via a second brake circuit 15. A first pressure medium reservoir 16 is assigned to the first brake circuit 13 and a second brake circuit 15 of the rear axle 14 is supplied with pressure medium via a second pressure medium reservoir 17.

The tractor vehicle brake system 1 includes a pneumatic coupling head 18 to which the trailer brake system 2 of the tractor vehicle 4 can be coupled. The tractor vehicle brake system 1 provides a pneumatic trailer brake pressure P-A for the trailer brake system 2 via the coupling head 18. In this case, the coupling head 18 is assigned a trailer control valve 19, which controls the connection between a third pressure reservoir 20 and the pneumatic coupling head 18. The trailer brake system 1 has a trailer brake circuit 21 in which the trailer brake pressure P-A provided by the tractor vehicle 1 prevails and can be switched through to all wheel brakes 7. By adjusting and providing the trailer brake pressure P-A, the brake control unit 9 of the tractor vehicle brake system 1 causes the trailer brake system 2 to provide a trailer braking force.

A pressure control valve 22, which can be electrically actuated, is connected upstream of each brake cylinder 8. In order to receive control signals, the pressure control valves 22 of the tractor vehicle brake system 1 are connected to the brake control unit 9, which influences the brake pressure P by corresponding control signals. The rotation behavior of the wheels 6 is also monitored. Each wheel 6 is each assigned a speed sensor 24, which generates measurement signals containing a statement about the rotation behavior of the respective wheel 6. The brake control unit 9 ascertains information about the slip of the respective wheel 6 from the measurement signals of the speed sensors 24.

The trailer vehicle 4 has an anti-lock brake system with a brake electronics system 23, which is configured to actuate the pressure control valves 22 on the brake cylinders of the trailer brake system 2 and to intervene in the event of a tendency of the wheels to lock during braking under the action of the trailer brake pressure P-A. The brake electronics system 23 monitors the slip of the individual wheels, which occurs when the brakes are operated, via the speed sensors 24. The braking force to be applied is pneumatically determined by the brake control unit 9 of the tractor vehicle via the trailer brake pressure P-A already provided. When a tendency of a single wheel to lock is established, the brake electronics system 23 counteracts locking of the affected wheels by actuating one or more pressure control valves 22 and regulating the brake pressure along the slip limit.

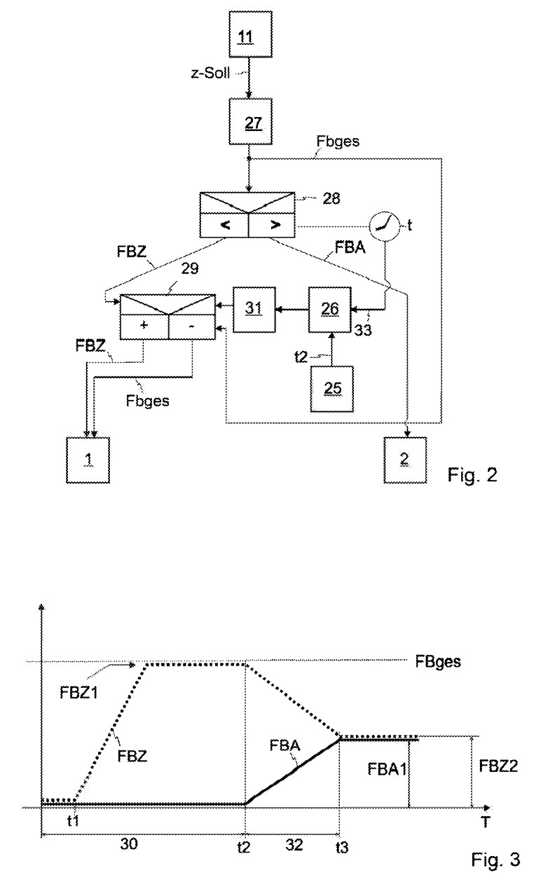

FIG. 2 illustrates a flow chart of an embodiment of the method for decelerating the vehicle combination 5, after the driver specifies a desired deceleration z-Soll by operating the brake pedal and the brake signal transmitter 11 of the brake control unit coupled to the brake pedal. After ascertaining 27 a total braking force FBges for implementing the desired deceleration z-Soll, the brake control unit determines a braking force distribution 28 for this total braking force FBges, that is, the braking force level of the tractor vehicle braking force FBZ, which is to be applied as part of the total braking force FBges from the tractor vehicle brake system 1, and the braking force level of the trailer braking force FBA to be applied by the trailer vehicle. According to the provided partial braking force FBA for the trailer vehicle, the brake control unit provides a trailer brake pressure and thus causes the trailer brake system 2 to implement the trailer braking force FBA. Taking into account the trailer braking force FBA, the tractor vehicle braking force FBZ, which is ultimately intended to reach the braking force level FBZ2 according to the braking force distribution 28, is adjusted 29. The brake control unit actuates the wheel brakes of the tractor vehicle brake system 1 accordingly.

The electronically controlled tractor vehicle brake system responds more quickly than the trailer brake system pneumatically addressed by the brake control unit 9 of the tractor vehicle via the trailer brake pressure P-A. A time profile of the partial braking forces FBZ, FBA is shown in FIG. 3. While the electronically controlled tractor vehicle brake system 1 begins to build up the tractor vehicle braking force FBZ as early as at time t1, the braking response of the trailer brake system 2 takes place at time t2. The effective trailer braking force FBA of the trailer brake system reaches the braking force level FBA1, which is determined according to the braking force distribution 28 requested (FIG. 2), only starting from time t3.

In order to implement the desired deceleration z-Soll as quickly as possible, the brake control unit initially adjusts the tractor vehicle braking force to a higher braking force level FBZ1 than is provided according to the braking force distribution 28 in a first braking phase 30 immediately after the desired deceleration z-Soll is received. Accordingly, the brake control unit actuates the tractor vehicle brake system to apply a greater braking force than the partial braking force which is provided according to the braking force distribution 28. In the embodiment shown, the tractor vehicle braking force FBZ is adjusted to an increased braking force level FBZ1, which corresponds to the total braking force Fbges requested, during the first braking phase 30.

The first braking phase 30 is terminated as soon as a deceleration effect of the trailer brake system occurs or is assumed. In the graphical profile of the partial braking forces according to FIG. 3, the first braking phase lasts until an active effect of the trailer brake system 2 occurs or is assumed at time t2.

The brake control unit 9 is configured to monitor, at the start of the deceleration process, whether the trailer brake system 2 has already become effective with its slower braking response and is actively participating in the deceleration of the vehicle combination 5. During the first braking phase 30, a deceleration effect 31 of the trailer brake system 2 is monitored 26 and the first braking phase 30 is terminated as soon as a deceleration effect 31 occurs or can be assumed.

After establishing or assuming a deceleration effect 31 of the trailer brake system at time t2, the initially greater tractor vehicle braking force FBZ of the tractor vehicle brake system 1, starting from the higher braking force level FBZ1, which corresponds to the total braking force FBges, is reduced in a transition phase 32 until time t3, at which the trailer braking force FBA reaches the provided braking force level FBA1, to the provided braking force level FBZ2, taking into account the current trailer braking force FBA. As early as during the transition phase 32, at the same time as the continuous increase in the partial braking force of the trailer brake system due to the effective trailer brake pressure, the electrical braking request made of the electronically controlled tractor vehicle brake system is returned reciprocally to the provided braking force level FBA1, so that the desired total braking force FBges is always effected by the sum of the two partial braking forces, that is, the sum of the tractor vehicle braking force FBZ and the trailer braking force FBA.

The occurrence of a deceleration effect 31 is established or assumed on the basis of the evaluation of a measured forecast variable 33. The deceleration effect 31 can be established if a variable that changes with the occurrence of the deceleration effect of the trailer brake system is measured and evaluated as the forecast variable 33. This may be the evaluation of a coupling force as a forecast variable, the coupling force being detected by a coupling force sensor. Another way to obtain the desired information about the occurrence of the deceleration effect and thus the end of the first braking phase is to evaluate a measured deceleration of the tractor vehicle as a forecast variable. In the case of semitrailer tractors, the change in axle load on one or more axles can be measured as a forecast variable which contains information about the occurrence of the deceleration effect.

In the embodiment shown, the deceleration effect 31 of the trailer brake system is monitored 26 indirectly by evaluating a braking time t as a forecast variable 33. When a certain braking time t2 is reached, a deceleration effect of the trailer brake system is assumed. The braking time t2, at which the trailer braking force FBA is assumed to take effect, is a specification 25, where the parameters for determining the specification are ascertained empirically. In the embodiment shown, the brake control unit of the electronic brake system links the start of the measurement of the braking time t2 to the pneumatic initiation of the trailer braking force FBA by providing the trailer brake pressure.

It is understood that the foregoing description is that of the preferred embodiments of the invention and that various changes and modifications may be made thereto without departing from the spirit and scope of the invention as defined in the appended claims.

### List of reference signs part of the description

1 Tractor vehicle brake system

2 Trailer brake system

3 Tractor vehicle

4 Trailer vehicle

5 Vehicle combination

6 Wheel

7 Wheel brake

8 Brake cylinder

9 Brake control unit

10 Brake pedal

11 Brake signal transmitter

12 Front axle

13 First brake circuit

14 Rear axle

15 Second brake circuit

16 First pressure medium reservoir

17 Second pressure medium reservoir

18 Coupling head

19 Trailer control valve

20 Third pressure medium reservoir

21 Trailer brake circuit

22 Pressure control valve

23 Brake electronics system

24 Speed sensor

25 Specifications

26 Monitoring

27 Ascertaining total deceleration

28 Braking force distribution

29 Adjusting braking force

30 First braking phase

31 Taking effect

32 Transition phase

33 Forecast variable

P Brake pressure

P-A Trailer brake pressure

z-Soll Desired deceleration

t Braking time

t1 Time

t2 Time

t3 Time

FBZ Tractor vehicle braking force

FBA Trailer braking force

FBZ1 Higher braking force level

FBZ2 Braking force level according to braking force distribution

FBA1 Braking force level

FBges Total braking force

1. A method for decelerating a vehicle combination including a tractor vehicle and at least one trailer vehicle, the method comprising:
determining, via a brake control unit of the tractor vehicle, a total braking force, which is to be applied jointly by a trailer brake system and a tractor vehicle brake system in a braking force distribution, when a desired deceleration is received;
causing, via the brake control unit, the trailer brake system to apply a trailer braking force and determine a tractor vehicle braking force taking into account a currently effective trailer braking force and adjusting the tractor vehicle braking force by actuating the tractor vehicle brake system; and,
wherein, in a first braking phase after receiving the desired deceleration, the tractor vehicle braking force is initially adjusted to a higher braking force level than is provided according to the braking force distribution.

2. The method of claim 1, wherein the tractor vehicle braking force is adjusted to a braking force level corresponding to the total braking force during the first braking phase and the tractor vehicle brake system is actuated accordingly.

3. The method of claim 1, further comprising:
monitoring, during the first braking phase, a deceleration effect of the trailer brake system; and,
terminating the first braking phase as soon as the deceleration effect occurs or is assumed.

4. The method of claim 3, wherein the deceleration effect of the trailer brake system is monitored indirectly via a measured forecast variable.

5. The method of claim 1, wherein, after establishing or assuming a deceleration effect of the trailer brake system, the initially higher tractor vehicle braking force of the tractor vehicle brake system is reduced in a transition phase taking into account the currently effective trailer braking force, to a braking force level of the tractor vehicle braking force provided according to the braking force distribution.

6. A brake control unit for the tractor vehicle of a vehicle combination including a tractor vehicle and at least one trailer vehicle, the brake control unit comprising:
an input configured to receive a desired deceleration;
a processor;
a non-transitory computer readable medium having program code stored thereon;
said program code being configured, when executed by said processor, to:
determine a total braking force, which is to be applied jointly by a trailer brake system and a tractor vehicle brake system in a braking force distribution, when a desired deceleration is received; and,
cause the trailer brake system to apply a trailer braking force and determine a tractor vehicle braking force taking into account a currently effective trailer braking force and adjust the tractor vehicle braking force by actuating the tractor vehicle brake system;
wherein, in a first braking phase after receiving the desired deceleration, the brake control unit is configured to initially adjust the tractor vehicle braking force to a higher braking force level than is provided according to the braking force distribution.
